(19) United States
(12) Patent Application Publication
(10) Pub. No.: US 2022/0297661 A1
(43) Pub. Date: Sep. 22, 2022

(54) METHOD FOR MONITORING THE RELEASE BEHAVIOR OF AN ELECTROMECHANICAL WHEEL BRAKE OF A VEHICLE

(71) Applicant: Continental Teves AG & Co. OHG, Frankfurt am Main (DE)

(72) Inventors: Andreas Kircher, Darmstadt (DE); Jürgen Böhm, Oberneisen (DE); Johann Jungbecker, Badenheim (DE)

(73) Assignee: Continental Teves AG & Co. OHG, Frankfurt am Main (DE)

(21) Appl. No.: 17/698,394

(22) Filed: Mar. 18, 2022

(30) Foreign Application Priority Data
Mar. 18, 2021 (DE) 10 2021 202 612.5

(51) Int. Cl. B60T 17/22

(52) U.S. Cl. CPC B60T 17/221; B60T 2270/406

(57) ABSTRACT

A method for monitoring the release behavior of an electromechanical wheel brake of a vehicle, the wheel brake having at least one electrically controllable force actuator configured to apply a brake-application force to friction partners of the wheel brake. comprises activating the force actuator in accordance with a defined control pattern which is dependent on a present operating state of the wheel brake, a present operating state of further wheel brakes of the vehicle, and/or a present operating state of the vehicle. The activation of the force actuator is interrupted at a defined point in time. The operating parameters of the wheel brake are monitored for a defined period of time after the interruption of the activation. The release behavior of the wheel brake is determined by ascertaining a reaction of the force actuator to the interruption of the activation on the basis of the ascertained operating parameters.

### CROSS-REFERENCE TO RELATED APPLICATIONS

The invention relates to a method for monitoring the release behavior of an electromechanical wheel brake of a vehicle. This U.S. patent application claims the benefit of German patent application No. 10 2021 202 612.5, filed Mar. 18, 2021, which is hereby incorporated by reference.

### TECHNICAL FIELD

The invention relates to a method for monitoring the release behavior of an electromechanical wheel brake of a vehicle.

### BACKGROUND

Electromechanical wheel brakes as service brakes for motor vehicles are known in a wide variety of variants in the prior art. Such an electromechanical brake for motor vehicles is described for example in DE 10 2017 206 798 A1. The described electromechanical brake comprises a brake caliper housing and a brake pad holder, a drive unit for generating a torque, a rotation-translation mechanism, and a mechanism unit for transmitting the torque to the rotation-translation mechanism. The torque of the drive unit may converted by the mechanism unit and the rotation-translation mechanism into a translational movement of a brake-application element, which causes brake pads to be pressed against a brake disk.

Such electromechanical wheel brakes are commonly characterized by the fact that there is a high mechanical speed ratio between the drive unit and the brake-application element. The high mechanical speed ratio means that the mechanical efficiency is less than 100%, and therefore a passive self-release of the brake after the ending of an activation of the drive unit is not automatically ensured. Such a self-release may commonly highly dependent on the loading of the components of the wheel brake over their service life, and on a state of lubrication of the components of the mechanism and of the drive of the wheel brake.

At the same time, a self-release of such an electromechanical brake in the passive, that is to say electrically deenergized state is a safety-critical function. For example, in the event of an electrical failure of the wheel brake, an applied electromechanical wheel brake could lead to an unstable driving state of the vehicle if the wheel brake, which is then no longer controllable, does not fully self-release.

It is also known to assist a passive release of an electromechanical brake, that is to say a reduction of the brake-application force without electronic activation of the actuator, by means of mechanical systems, for example a spring loading of bearing elements of the wheel brake. Such a system is described for example in DE 10 2019 219 331 A1. Although such a system increases the likelihood of a self-release, it cannot ensure the intended release behavior of the wheel brake in all situations.

### SUMMARY

A method for monitoring the release behavior of an electromechanical wheel brake of a vehicle, the electromechanical wheel brake having at least one electrically controllable force actuator, the force actuator being configured to apply a brake-application force to friction partners of a wheel brake for the purposes of decelerating the vehicle comprises activating the force actuator in accordance with a defined control pattern, the control pattern being dependent on a present operating state of the wheel brake and/or a present operating state of further wheel brakes of the vehicle and/or a present operating state of the vehicle, interrupting the activation of the force actuator at a defined point in time, monitoring operating parameters of the wheel brake for a defined period of time after the interruption of the activation, and determining the release behavior of the wheel brake by ascertaining a reaction of the force actuator to the interruption of the activation on the basis of the ascertained operating parameters.

A “force actuator” may be understood to at least in one definition mean a device that can apply a controllable force to an element of the wheel brake, in the present case to the friction partners of the wheel brake, which force presses the friction partners against one another such that a braking force which decelerates the rotation of a vehicle wheel acts on the vehicle wheel connected to the wheel brake. The friction partners may for example be a brake disk, which is connected rigidly to the vehicle wheel, and friction pads, which act on the brake disk, wherein the friction pads may be subjected to a force in the direction of the brake disk by the force actuator. The force that acts on the friction pads in the direction of the brake disk is referred to here as “brake-application force”. However, the wheel brake is not restricted to the described configuration as a disk brake. Rather, the concept may also be implemented in some other type of brake, for example an electromechanical drum brake.

At least one embodiment is based on the consideration of simulating, by activation of the force actuator in accordance with a defined and thus replicable pattern and subsequent interruption of the activation, a situation in which targeted control of the force actuator is no longer possible, for example owing to an electrical failure. From the reaction of the force actuator to this interruption, which can be ascertained from an observation of the operating parameters of the brake, it is then possible to check whether the wheel brake would self-release to the required degree even in the event of a fault. If it is ascertained that a self-release would not take place to a sufficient degree, it is for example possible for a warning to be output to the vehicle driver. Furthermore, the activation of the affected wheel brake may be correspondingly adapted such that, for example by means of a change in the brake force distribution, the wheel brake is involved to a lesser degree in implementing a braking demand.

According to one embodiment, provision is made for a first control pattern to comprise the setting and holding of a defined brake-application force by the force actuator of the wheel brake, the first control pattern being implemented only when the vehicle is stationary. This control pattern simulates the situation in which the controller of the wheel brake suddenly fails while an application force is being applied. For this situation, the brake-application force of the wheel brake should ideally decrease of its own accord to such a degree that any remaining residual application force does not significantly influence the driving behavior of the vehicle. However, if it is ascertained that the brake-application force does not decrease to a sufficient degree after interruption of the activation, this may be an indication of a safety-critical state of wear or lubrication of the components of the wheel brakes.

The implementation of the first control pattern when the vehicle is stationary is intended to prevent driving behavior that is unexpected for the vehicle driver from occurring during an execution of the method. According to one embodiment, the stationary state of the vehicle for the implementation of the first control pattern is ensured by virtue of the vehicle being held stationary through the implementation of a parking brake function by means of at least a proportion of the wheel brakes of the vehicle. During the course of the parking brake function, provision is made for at least a subset of the wheel brakes to be activated such that the respective force actuators collectively set a brake-application force that is sufficient to prevent the vehicle from rolling away. A parking brake function may for example also be implemented only by means of a proportion of the wheel brakes, for example by means of the wheel brakes of a rear axle of the vehicle. The first control pattern may basically be implemented both at those wheel brakes which are not involved in the implementation of the parking brake function and at those wheel brakes which hold the vehicle in the parked position.

In order to ensure that the vehicle continues to be securely held in the parked braked position when the parking brake function is active, despite the interruption of the activation of a wheel brake involved in implementing the parking brake function in the context of the method, it is provided according to a further embodiment that, before the interruption of the activation of the wheel brake in the first control pattern, it is ascertained whether the further wheel brakes of the vehicle are collectively imparting a braking force that is sufficient to hold the vehicle stationary, the defined brake-application force of the wheel brake being set to a value higher than a brake-application force for implementing the parking brake function if the braking force imparted by the further wheel brakes is not sufficient to hold the vehicle stationary.

A distinction can be made substantially between two cases. In the first case, the first control pattern is implemented at a wheel brake that is not involved in the implementation of the parking brake function. In this case, the method can be implemented without limitation at the wheel brake in question, because there is no change to the parking brake situation.

In the second case, the method is implemented at a wheel brake that is involved in the implementation of the parking brake function. In this case, it must be ensured that the interruption of the activation of the corresponding force actuator does not cause the acting braking force to drop to such a degree that the vehicle can no longer be securely held in its parked position. According to one embodiment, this is achieved by ascertaining in advance whether a reduction of the brake-application force of the wheel brake under examination can become a problem for maintaining the parked braked position. If so, the brake-application force of the wheel brake is initially increased to such a degree that an interruption of the activation, and consequently a partial drop of the brake-application force, does not result in the overall braking force imparted by the wheel brakes of the vehicle falling below a braking force level that is required for maintaining the parking brake function.

According to a further embodiment, provision is furthermore made for the force actuator to have a pressure piston that is actuatable by electric motor or an application element that is actuatable by electric motor, a brake-application force provided by the force actuator being generated by application of a force to the pressure piston or application element along a brake-application direction of the wheel brake by the force actuator. A friction pad may be arranged on the pressure piston such that, when the pressure piston or application element is displaced in a brake-application direction, the friction pad is brought into contact with a brake disk and is subjected to a force in the direction of the brake disk.

In the case of such a configuration of the wheel brake, provision is made, according to a further embodiment, for a second control pattern to comprise the acceleration of the pressure piston or application element along the brake-application direction without a brake-application force being generated. The control pattern may accordingly be implemented for as long as there is a sufficient air gap between the friction partners of the wheel brake, that is to say the friction partners are not in contact with one another. The pressure piston may be accelerated to a defined speed or as far as a defined position along the possible displacement travel and, when the speed or position is reached, the activation of the force actuator is interrupted and consequently the acceleration of the pressure piston by the force actuator is ended. From the deceleration of the pressure piston after the interruption of the activation, it may be estimated how free-moving the mechanism of the wheel brake is, which in turn indicates to what degree, or how quickly, an acting brake-application force of the wheel brake would be depleted in the event of a failure of the controller or power supply.

It may not be necessary to wait until the pressure piston or the application element comes to a complete standstill. It is rather also possible to ascertain how long it takes until the pressure piston or the application element has been braked from an initial speed, after the ending of the acceleration, to a target speed. Alternatively, after the acceleration has occurred, it is also possible to ascertain the time required by the pressure piston or the application element in a free-running situation to reach a defined actuation position along the brake-application direction.

According to a further embodiment, provision is furthermore made for a third control pattern to comprise the reduction of a brake-application force that is acting owing to a brake actuation. This control pattern can for example be used when a braking demand is ended, for example by virtue of the actuation of a brake pedal being withdrawn, such that the wheel brakes are controlled so as to deplete an acting brake-application force. The brake-application force of the wheel brake initially decreases in a controlled manner proceeding from an initial value. In the course of the third control pattern, provision is made for at least a part of this release operation, which is in fact controlled, to be allowed to take place in uncontrolled fashion. It is thus possible during the active operation of the wheel brake to ascertain whether the brake would continue to release to a sufficient degree even in the event of a failure of the controller.

According to a further embodiment, for the determination of the release behavior, provision is furthermore made for the operating parameters of the wheel brake that are monitored after an interruption of the activation to include the profile with respect to time of an acting brake-application force and/or the profile with respect to time of an actuating travel of the wheel brake. The brake-application force and the actuating travel may be ascertained for example by means of existing sensors for the purposes of controlling the force actuator, and provide direct information regarding the behavior of the force actuator in a free-running situation. An “actuating travel” is to be understood for example to mean a displacement travel of the pressure piston or of the application element along a brake-application direction. Such an actuating travel may either be directly measured by means of corresponding travel sensors or ascertained from operating parameters of the force actuator, for example a motor position of an electric motor drive and the mechanism position of a mechanism connected downstream of the motor.

According to a further embodiment, provision is made for the release behavior to be ascertained from a difference in the actuating travel or from a difference in the brake-application force over a time difference, the release behavior being identified as being insufficient if the ascertained difference in the actuating travel or the ascertained difference in the brake-application force is below a threshold value. A value below the threshold value may indicate that the mechanism of the wheel brake is more inert than it should be, such that it is no longer possible to assume a reliable release behavior of the wheel brake. Consideration may also be given to the difference in the brake-application force versus the difference in the actuating travel.

According to a further embodiment, provision is made for the release behavior to be ascertained from a gradient with respect to time of the actuating travel or of the brake-application force, the release behavior being identified as being insufficient if the ascertained gradient of the actuating travel or the ascertained gradient of the brake-application force is below a threshold value.

In the above-described variants for the determination of the release behavior of the wheel brake, aside from a direct consideration of the behavior of the force actuator, provision may also be made for further parameters that influence the release behavior of the force actuator to be taken into consideration. For example, consideration may also be given to a temperature of the wheel brake or of components of the wheel brake, e.g. the force actuator. For example, the temperature influences the viscosity of lubricants that are used in the wheel brake, which can have a direct impact on the release behavior of the wheel brake. By considering and taking into consideration the temperature, a distinction can accordingly be made as regards whether a release behavior identified as being insufficient is merely based on too low a temperature, or whether a critical state of wear or defect of the wheel brake is in fact present.

Furthermore, the different control patterns may be implemented multiple times with different parameters, such that an actual release behavior can be interpolated from the partial results for the different parameters. For example, in the case of the first control pattern, provision may be made for different levels of the brake-application force to be used, such that the release behavior proceeding from different starting conditions can be evaluated. Furthermore, in the case of the second control pattern, different speeds of the pressure piston can be examined. In the case of the third control pattern, that point of the release operation proceeding from which the release of the brake should occur of its own accord can be varied, said point being represented by an acting residual application force or a time since the commencement of the reduction of the brake-application force.

Furthermore, provision may be made whereby, before the implementation of the actuation pattern, the force actuator of the wheel brake under examination is moved one or more times through a defined stroke. This may be helpful if the force actuator has been held in a particular actuation position for a relatively long period of time, which can result in an increase of the breakaway torque of the force actuator. This changed breakaway torque in turn influences the determination of the self-release behavior of the wheel brake. By means of a single or repeated slight back-and-forth movement of the force actuator, the breakaway torque of the force actuator can in turn be evened out, such that the accuracy of a subsequent examination of the release behavior is improved.

### BRIEF DESCRIPTION OF THE DRAWINGS

The present disclosure will become more fully understood from the detailed description and the accompanying drawings, wherein:

FIG. 1 shows a flow diagram of an exemplary method;

FIG. 2 is a schematic illustration of an exemplary force-travel profile of an electromechanical wheel brake;

FIG. 3 is a further schematic illustration of the exemplary force-travel profile of an electromechanical wheel brake; and

FIG. 4 is a schematic illustration of the behavior of a force actuator during the implementation of an exemplary control pattern.

### DETAILED DESCRIPTION

In the following text, features that are similar or identical are denoted by the same reference signs.

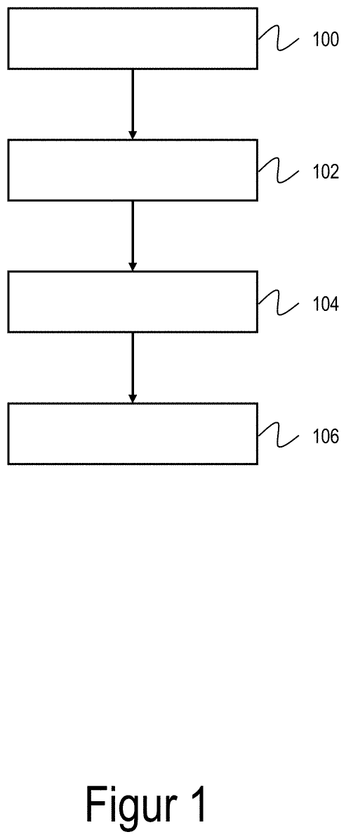

FIG. 1 shows a flow diagram of an exemplary embodiment of a method. In a first method step 100, the force actuator of an electromechanical wheel brake is activated in accordance with a defined control pattern. The force actuator may for example be an arrangement with an electromotive drive, downstream of which there is connected a mechanism arrangement with a rotation-translation mechanism, such that a rotation of a drive shaft of the drive is converted into a translational movement. A pressure piston or an application element of a wheel brake may be coupled to the mechanism, such that a rotation of the drive shaft of the drive, or a torque acting on the drive shaft, is converted into a translational movement of the pressure piston or application element or a force acting on the pressure piston or the application element along a brake-application direction.

The movement of pressure piston or application element, or an exertion of a force on said elements, may cause friction partners of a friction brake to be brought into contact with one another, or to be pressed against one another with a force that is controllable by the controller of the electromotive drive. The friction force that is thus generated causes a braking torque or moment to be exerted on a vehicle wheel that is operatively connected to the wheel brake, which braking torque or moment brakes or prevents a rotation of the vehicle wheel.

The control pattern in accordance with which the force actuator is activated is dependent on a present operating state of the wheel brake under consideration. For example, the operating state of the wheel brake describes whether the wheel brake is presently exerting a braking force on the associated vehicle wheel, or the wheel brake is situated in an open state, that is to say the friction partners of the wheel brake are not in contact. A further influential factor may also be whether the wheel brake is presently being used to decelerate the vehicle, or whether the wheel brake is being used to implement a parking brake function that is intended to prevent the vehicle from rolling away from a parked brake position. Accordingly, an operating state of the vehicle may also have an influence on what type of control pattern is used in the context of the method. The operating state of the vehicle may for example be ascertained from a wheel rotational speed of a wheel associated with the wheel brake under consideration. Finally, in the selection of the control pattern used, consideration may also be given to the present operating state of the further wheel brakes of the vehicle, that is to say whether the further wheel brakes are presently being used to generate braking forces, and, if applicable, how high these braking forces are.

Subsequently, in step 102, the activation of the force actuator, that is to say the implementation of the control pattern, is interrupted at a defined point in time. The interruption may be performed such that the activation of the force actuator, which activation was previously controlled within the scope of the control pattern, is stopped, that is to say no further control commands are output to the force actuator. In this way, it is for example possible to simulate an interruption of the power supply of the wheel brake or a failure of the controller owing to an interruption of the signal transmission or a fault of the control unit.

Subsequently, in step 104, it is ascertained how the wheel brake, and in particular the force actuator with the elements positioned downstream of the force actuator in the action chain (mechanism and friction partners), behaves after the interruption of the activation. For this purpose, the operating parameters of the wheel brake are monitored for a defined period of time after the interruption of the activation. A profile of the position of a pressure piston or application element, or an application force imparted by means of the pressure piston or application element, may be recorded versus the time that has elapsed since the interruption of the activation.

From the data thus ascertained, it is subsequently ascertained in step 106 whether the release behavior of the wheel brake in the event of an interruption of the activation is sufficient to continue to ensure a sufficient self-release action in the event of a failure of the controller or power supply of the wheel brake. Should it be identified that the release behavior is insufficient, that is to say if, in the event of a fault, an acting braking force is depleted too slowly or the wheel brakes maintain a brake-application force that is too high, provision may furthermore be made for the wheel brake to no longer be used, or to be used only to a limited degree, for implementing a braking demand, and for a corresponding warning to be output to the vehicle driver.

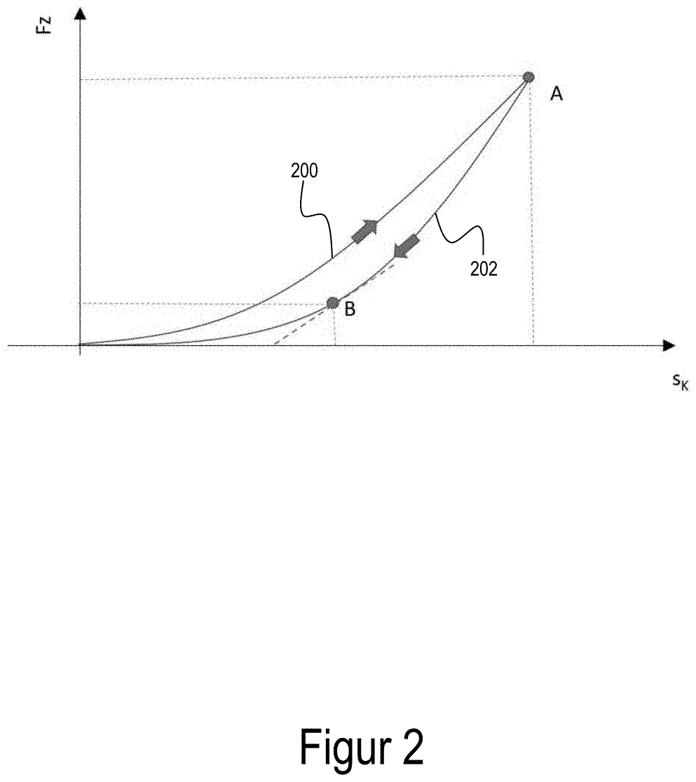

Different variants of control patterns will be described by way of example below with reference to FIGS. 2, 3 and 4.

In this regard, FIG. 2 shows an exemplary profile of the brake-application force F_{z} of an electromechanical wheel brake versus the displacement travel s_{K} of a pressure piston or of an application element of the electromechanical wheel brake. The profile of the brake-application force upon an application of the wheel brake, that is to say an increase of the brake-application force 200, differs from the profile of the brake-application force in the event of a release of the wheel brake, that is to say a reduction of the brake-application force 202.

A first variant of a control pattern may be such that the force actuator sets a defined brake-application force A and maintains this over a relatively long period of time. This may be provided for example for the implementation of a parking brake function, wherein, in this case, the corresponding brake-application force is selected such that the wheel brakes that are involved in implementing the parking brake function collectively provide a braking force that prevents the vehicle from rolling away.

Upon an interruption of the activation of the force actuator, a deformation energy of the wheel brake, for example of the brake caliper, that is commonly stored in the applied wheel brake causes the pressure piston or the application element to be acted on with a force that leads to a release of the brake, that is to say a movement of the pressure piston or application element counter to the brake-application direction. The acting brake-application force is also reduced, wherein the degree to which the brake-application force changes during a movement of the pressure piston or application element over a defined distance provides information regarding whether the wheel brake would self-open to a sufficient degree in the event of a fault. Aside from a consideration of the acting brake-application force F_{z} versus the displacement travel s_{K}, it is alternatively or additionally also possible to ascertain and take into consideration the acting brake-application force F_{z} versus the time t since the interruption of the activation. Furthermore, both differences in brake-application forces ΔF_{z} over different time differences Δt or differences in the displacement travel Δs_{K} may be considered, or corresponding gradients calculated, in order to quantify the release behavior of the wheel brake.

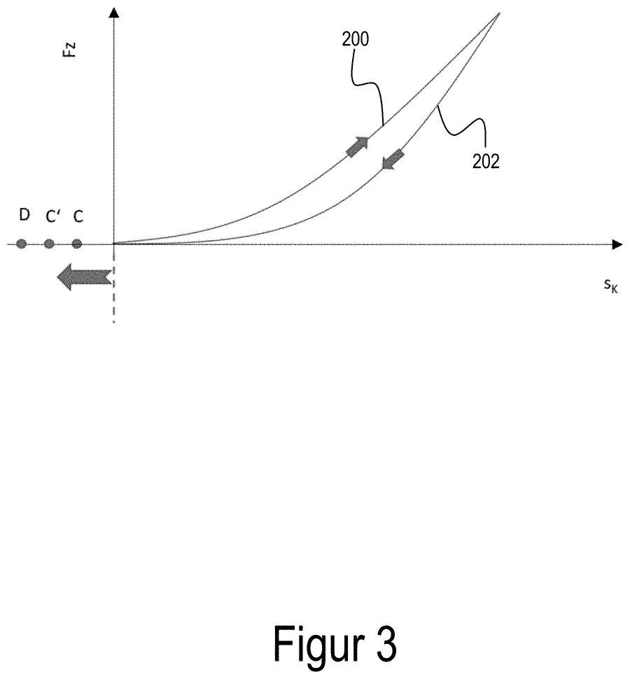

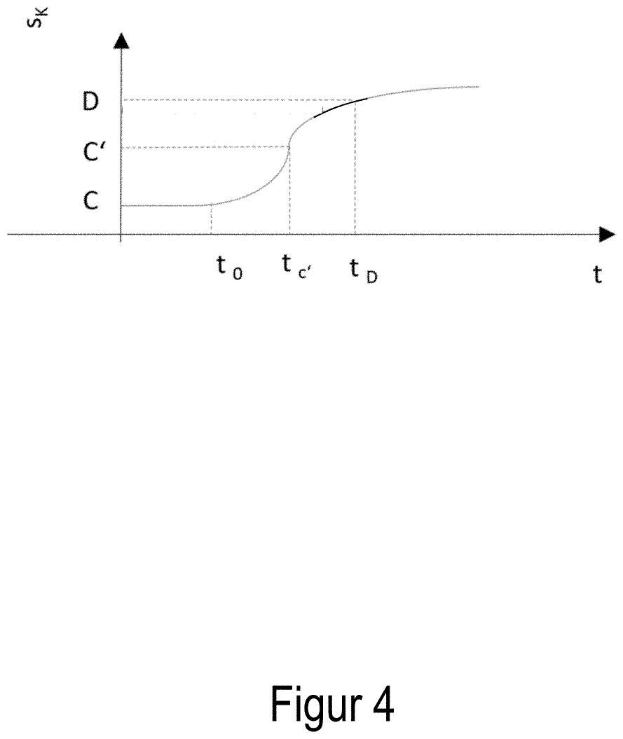

An example of a second control pattern will be described below with reference to FIGS. 3 and 4. FIG. 3 shows once again the exemplary profile, already described with reference to FIG. 2, of the brake-application force F_{z} of an electromechanical wheel brake versus the displacement travel s_{K} of a pressure piston or of an application element of the electromechanical wheel brake. However, in this embodiment the range of the displacement travel s_{K} that is arranged to the left of the vertical coordinate axis. In this range, a displacement of the pressure piston or application element takes place without building up a brake-application force. Consequently, the origin of the coordinate system describes the point along the displacement travel s_{K} at which the friction partners of the wheel brake come into contact. The range to the left of the coordinate origin describes the air gap range of the wheel brake, that is to say the range in which the friction partners do not come into contact and, therefore, it may initially also be the case that no brake-application force builds up during a displacement of the friction partners.

As a second control pattern, provision is now made, in this range, for the pressure piston or the application element to be accelerated along the displacement travel s_{K} proceeding from a point C. Once the pressure piston or the application element reaches the point C′, the activation of the force actuator is interrupted. It is subsequently observed how long the pressure piston or the application element takes to reach the point D along the displacement travel s_{K}.

In this regard, FIG. 4 illustrates, by way of example, the position of the pressure piston or application element s_{K} along the displacement travel versus the time t during an implementation of the second control pattern. An accelerated movement of the pressure piston or application element initially starts, proceeding from a position C, at the time t₀. At the point C′, or at the time t′_{c} corresponding to this, the activation of the force actuator may be interrupted, such that the pressure piston or the application element run down and the speed decreases again until, at the point D, at a corresponding time t_{D}, the speed falls below a threshold value. From the duration Δt=t_{D}−t′_{c}, it can then be ascertained whether the free running of the force actuator exhibits sufficiently free movement that a reliable release behavior of the electromechanical wheel brake may be assumed.

A third control pattern may also be described by way of example, proceeding again from the illustration of FIG. 2. The force actuator is initially activated such that a defined brake-application force acts at the point A. This may for example be a brake-application force resulting from a braking demand, which may be triggered for example by an actuation of a brake pedal by a vehicle driver. Subsequently, in a manner controlled on the basis of an ending of the braking demand, the brake-application force F_{z} is depleted, along the curve 202, by corresponding activation of the force actuator. At a defined point B, however, the activation of the force actuator is interrupted, such that a proportion of the depletion of force is performed by the wheel brake alone. If one for example again considers the gradient of the brake-application force F_{z} versus the displacement travel s_{K} or the time t that has elapsed since the interruption of the activation, the self-release capability of the wheel brake may again be determined.

The above-described control patterns may be combined in any desired manner to form a monitoring profile for the electromechanical wheel brake, such that the release behavior of the wheel brake can be ascertained in different ways in different situations.

What is claimed is:

1. A method for monitoring the release behavior of an electromechanical wheel brake of a vehicle comprising:
activating a force actuator to apply a brake application force to friction partners of a wheel brake with a defined control pattern, which is dependent on at least one of a present operating state of the wheel brake, a present operating state of further wheel brakes of the vehicle, and a present operating state of the vehicle;
interrupting the activation of the force actuator at a defined point in time;
monitoring operating parameters of the wheel brake for a defined period of time after the interruption of the activation; and
determining release behavior of the wheel brake by ascertaining a reaction of the force actuator to the interruption on the basis of the ascertained operating parameters.

2. The method as claimed in claim 1, wherein the defined control pattern is a first control pattern which comprises setting and holding the defined brake-application force with the force actuator of the wheel brake.

3. The method as claimed in claim 2, wherein the first control pattern being implemented only when the vehicle is stationary.

4. The method as claimed in claim 2, further comprising implementing a parking brake function which causes the vehicle to be held stationary by at least a proportion of the wheel brakes of the vehicle.

5. The method as claimed in claim 4, further comprising:
ascertaining whether the further wheel brakes of the vehicle are collectively imparting a braking force that is sufficient to hold the vehicle stationary before the interruption of the activation; and
setting the defined brake-application force to a value higher than a brake-application force for implementing the parking brake function when the braking force imparted by the further wheel brakes is not sufficient to hold the vehicle stationary.

6. The method as claimed in claim 1, further comprising applying a force to one of a pressure piston that is actuatable by electric motor and an application element that is actuatable by electric motor to provide the brake application force.

7. The method as claimed in claim 6, wherein the defined control pattern is a second control pattern which comprises accelerating one of the pressure piston and the application element along the brake-application direction without generation of the brake-application force.

8. The method as claimed in claim 1, wherein the defined control pattern is a third control pattern which comprises reducing a brake-application force that is acting due to a brake actuation.

9. The method as claimed in claim 1, wherein the operating parameters which are monitored comprise at least one of: a profile of the acting brake-application force with respect to time, and the profile of an actuating travel of the wheel brake with respect to time.

10. The method as claimed in claim 9, wherein determining the release behavior is ascertained from one of a difference in the actuating travel and a difference in the brake-application force over a time difference.

11. The method as claimed in claim 10, wherein the release behavior is identified as insufficient when the ascertained difference in the one of the actuating travel and the brake-application force is below a threshold value.

12. The method as claimed in claim 9, wherein determining the release behavior is ascertained from one of a gradient of the actuating travel with respect to time and the brake-application force.

13. The method as claimed in claim 12, wherein the release behavior is identified as insufficient when the ascertained gradient of the actuating travel or the ascertained gradient of the brake-application force is below a threshold value.
